(19) United States
(12) Patent Application Publication
(10) Pub. No.: US 2020/0136150 A1
(43) Pub. Date: Apr. 30, 2020

(54) METHOD OF MAKING A LAYERED ELECTROLYTE

(71) Applicant: PHILLIPS 66 COMPANY, Houston, TX (US)

(72) Inventors: Mingfei Liu, Bartlesville, OK (US); Ying Liu, Bartlesville, OK (US)

(73) Assignee: PHILLIPS 66 COMPANY, HOUSTON, TX (US)

(21) Appl. No.: 16/668,792

(22) Filed: Oct. 30, 2019

Related U.S. Application Data
(60) Provisional application No. 62/752,680, filed on Oct. 30, 2018.

(51) Int. Cl. H01M 4/88; H01M 4/90; H01M 4/86

(52) U.S. Cl. CPC H01M 4/8828; H01M 4/8621; H01M 4/9066

(57) ABSTRACT

A method of forming a solid oxide fuel cell. The method begins by tape casting an anode support. Next an anode functional layer slurry comprising of NiO and ScCeSZ ceramic powder is coated onto the anode support. The anode functional layer slurry is then dried to form an NiO—ScCeSZ anode functional layer on the anode support. A first electrolyte layer comprising of a ScCeSZ slurry is then coated onto the NiO—ScCeSZ functional layer. The first electrolyte layer is then dried to form a ScCeSZ electrolyte layer on the NiO—ScCeSZ functional layer. A second electrolyte layer comprising of a samarium doped CeO₂ (SDC) slurry is then coated onto the ScCeSZ electrolyte layer. The second electrolyte layer is then dried to form a SDC electrolyte layer on the ScCeSZ electrolyte layer. The combined anode support, the NiO—ScCeSZ anode functional layer, the ScCeSZ electrolyte layer, and the SDC electrolyte layer is then sintered together. A cathode slurry is then coated onto the SDC electrolyte layer to form a cathode layer. A solid oxide fuel cell is then formed when the combined anode support, the NiO—ScCeSZ anode functional layer, the ScCeSZ electrolyte layer, the SDC electrolyte layer, and the cathode layer is then sintered together.

### CROSS-REFERENCE TO RELATED APPLICATIONS

This application is a non-provisional application which claims the benefit of and priority to U.S. Provisional Application Ser. No. 62/752,680 filed Oct. 30, 2018, titled “Method of Making a Layered Electrolyte,” which is hereby incorporated by reference in its entirety.

### STATEMENT REGARDING FEDERALLY SPONSORED RESEARCH OR DEVELOPMENT

None.

### FIELD OF THE INVENTION

This invention relates to a method of making a layered electrolyte.

### BACKGROUND OF THE INVENTION

Fuel cells, particularly solid oxide fuel cells (SOFCs) are regarded as one of the most efficient technologies for generating electricity directly from a wide variety of fuels, including hydrogen, light hydrocarbons, coal gas, bio-derived gases, and other renewable solid wastes. Recently, intermediate-temperature SOFCs have attracted worldwide attention because lowering the operating temperature (from about 1000° C. to about 550-750° C.) has the potential to considerably widen the selection of less expensive materials for SOFC stacks and systems to reduce the cost while improving the reliability and operational life of SOFC systems. Lowering the operating temperature, however, creates a number of materials issues that are associated with the increase in the electrolyte resistance and decrease in the rates of the electro-catalytic reactions (electrode polarization). Both factors could result in a significant decrease in fuel cell performance. Therefore, developing high-performing materials as well as novel structure concepts is essential to achieving high performance at a low temperature range.

Yttria-stabilized zirconia (YSZ) is the most mature and widely used SOFC electrolyte. However, the relatively low conductivity of YSZ limits its operation to high temperatures (i.e., >750° C.). In addition, YSZ is chemically incompatible with the commonly used high-performing alkaline-earth-metal-containing cathodes due to high resistivity phases such as La₂Zr₂O₇ and SrZrO₃ formed at the electrode/electrolyte interface during cathode fabrication. Formation of these insulating phases increases both the ohmic resistance of fuel cells and the polarization resistance of the cathode. Both would cumulatively reduce the overall cell performance. Although nano-structures prepared using low-temperature, in-situ assembly methods and infiltration techniques have been reported in the literature, the long-term stability of these structures has not been validated under real fuel cell operating conditions. To avoid the adverse chemical reactions between the cathode and YSZ electrolyte, a thin doped-ceria (gadolinium-doped ceria, GDC) barrier layer is typically inserted between these two layers. The barrier layer also has the tendency to react with the YSZ electrolyte and form (Zr, Ce)O₂-based solid solutions at temperatures higher than 1200° C. The new solid solutions have a much lower ionic conductivity than GDC and YSZ. On the other hand, it is very difficult to obtain a fully dense barrier layer with conventional fabrication methods at temperatures lower than 1300° C. The conductivity of the porous barrier layer is low and the interdiffusion between the cathode and the YSZ electrolyte may affect the overall SOFC performance and stability.

Another well-known electrolyte for low-temperature operation is doped ceria (either Gd or Sm doped, GDC and SDC) because of its high ionic conductivity in the intermediate temperature range and better chemical compatibility with lanthanum-strontium-cobaltite (LSC) and lanthanum-strontium-ferrite (LSF) cathodes. However, doped ceria is reducible at very low oxygen partial pressure and exhibits mixed electronic-ionic conductivity, which reduces the fuel cell efficiency, more so with thinner electrolyte membranes at higher operating temperatures. In addition, the partial reduction of ceria (from Ce⁴⁺ to Ce³⁺) upon exposure to a reducing atmosphere causes a remarkable volume change, which might result in severe structural and mechanical degradation (such as microcrack formation and delamination). To better utilize the high ionic conductivity of the doped-ceria electrolyte, additional layers have been introduced to block the electronic conduction of the doped-ceria membranes and enhance the open circuit voltage of the ceria-based cells. Although improved open circuit voltages have been demonstrated, the fuel cell power densities were still much lower than those of pure ceria-based cells. Another limitation of the bi-layer concept (e.g., samarium strontium cobaltite (SSZ)/samarium-doped ceria (SDC) or YSZ/SDC) is that the high co-firing temperature causes the interdiffusion (or interaction) between electrolyte layers under co-firing conditions, which not only dramatically reduced the conductivity, but also introduced significant electronic conduction, resulting in performance loss.

There exists a need for a bi-layer concept capable of enhanced SOFC performance.

### BRIEF SUMMARY OF THE DISCLOSURE

A method of forming a solid oxide fuel cell. The method begins by tape casting an anode support. Next an anode functional layer slurry comprising of NiO and scandia-ceria stabilized zirconia (ScCeSZ) ceramic powder is coated onto the anode support. The anode functional layer slurry is then dried to form an NiO—ScCeSZ anode functional layer on the anode support. A first electrolyte layer comprising of a ScCeSZ slurry is then coated onto the NiO—ScCeSZ functional layer. The first electrolyte layer is then dried to form a ScCeSZ electrolyte layer on the NiO—ScCeSZ functional layer. A second electrolyte layer comprising of a samarium doped CeO₂ (SDC) slurry is then coated onto the ScCeSZ electrolyte layer. The second electrolyte layer is then dried to form a SDC electrolyte layer on the ScCeSZ electrolyte layer. The combined anode support, the NiO—ScCeSZ anode functional layer, the ScCeSZ electrolyte layer, and the SDC electrolyte layer is then sintered together. A cathode slurry is then coated onto the SDC electrolyte layer to form a cathode layer. A solid oxide fuel cell is then formed when the combined anode support, the NiO—ScCeSZ anode functional layer, the ScCeSZ electrolyte layer, the SDC electrolyte layer, and the cathode layer is then sintered together.

A method of forming a solid oxide fuel cell. The method begins by tape casting an anode support. Next an anode functional layer slurry comprising of NiO, ScCeSZ ceramic powder, and ethyl alcohol is spray coated onto the anode support. The anode functional layer slurry is then dried, at temperatures less than 50° C., to form an NiO—ScCeSZ anode functional layer on the anode support. A first electrolyte layer comprising of a ScCeSZ slurry is then spray coated onto the NiO—ScCeSZ functional layer. The first electrolyte layer is then dried, at temperatures less than 50° C., to form a ScCeSZ electrolyte layer on the NiO—ScCeSZ functional layer. A second electrolyte layer comprising of a SDC slurry is then spray coated onto the ScCeSZ electrolyte layer. The second electrolyte layer is then dried, at temperatures less than 50° C., to form a SDC electrolyte layer on the ScCeSZ electrolyte layer. The combined anode support, the NiO—ScCeSZ anode functional layer, the ScCeSZ electrolyte layer, and the SDC electrolyte layer is then sintered together, at temperatures from about 1,000° C. to about 1,300° C. The combined anode support, the NiO—ScCeSZ anode functional layer, the ScCeSZ electrolyte layer, and the SDC electrolyte layer is then cooled to room temperature. A cathode slurry is then spray coated onto the SDC electrolyte layer to form a cathode layer. A solid oxide fuel cell is then formed when the combined anode support, the NiO—ScCeSZ anode functional layer, the ScCeSZ electrolyte layer, the SDC electrolyte layer, and the cathode layer is then sintered together, at a temperature below 1,000° C.

A method of forming a solid oxide fuel cell. The method begins by tape casting an anode support. Next an anode functional layer slurry comprising of 5 wt % NiO and 4.5 wt % ScCeSZ ceramic powder, and ethyl alcohol is ultrasonic spray coated onto the anode support. The spray coating is done four times at a deposition rate of 1.0 mL/min. The anode functional layer slurry is then dried, at temperatures less than 50° C., to form an NiO—ScCeSZ anode functional layer on the anode support. A first electrolyte layer comprising of a 3 wt % ScCeSZ slurry is then ultrasonic spray coated onto the NiO—ScCeSZ functional layer. The first electrolyte layer is then dried, at temperatures less than 50° C., to form a ScCeSZ electrolyte layer on the NiO—ScCeSZ functional layer. The thickness of the ScCeSZ electrolyte layer ranges from about 1.5 μm to about 2.5 μm. A second electrolyte layer comprising of a 10 wt % SDC slurry is then ultrasonic spray coated onto the ScCeSZ electrolyte layer. The second electrolyte layer is then dried, at temperatures less than 50° C., to form a SDC electrolyte layer on the ScCeSZ electrolyte layer. The thickness of the SDC electrolyte layer ranges from about 9.5 μm to about 10.5 μm. The combined anode support, the NiO—ScCeSZ anode functional layer, the ScCeSZ electrolyte layer, and the SDC electrolyte layer is then sintered together, at temperatures from about 1,000° C. to about 1,300° C. The combined anode support, the NiO—ScCeSZ anode functional layer, the ScCeSZ electrolyte layer, and the SDC electrolyte layer is then cooled to room temperature. A cathode slurry is then spray coated onto the SDC electrolyte layer to form a cathode layer. A solid oxide fuel cell is then formed when the combined anode support, the NiO—ScCeSZ anode functional layer, the ScCeSZ electrolyte layer, the SDC electrolyte layer, and the cathode layer is then sintered together, at a temperature below 1,000° C.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a method of making a novel fuel cell.

FIG. 2 depicts a novel fuel cell.

FIG. 3 depicts the XRD patterns of pure ScCeSZ and SDC powders and their mixture.

FIG. 4 depicts the performance of two layered electrolyte cells sintered at different temperatures.

FIG. 5 depicts the open circuit voltages of a layered electrolyte cell and an SDC electrolyte cell at 550-750° C.

FIG. 6 depicts the power densities of a layered electrolyte cell, a YSZ electrolyte cell, and an SDC electrolyte cell as a function of temperature.

FIG. 7 depicts the AC impedance analysis of a layered electrolyte cell and a YSZ electrolyte cell.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

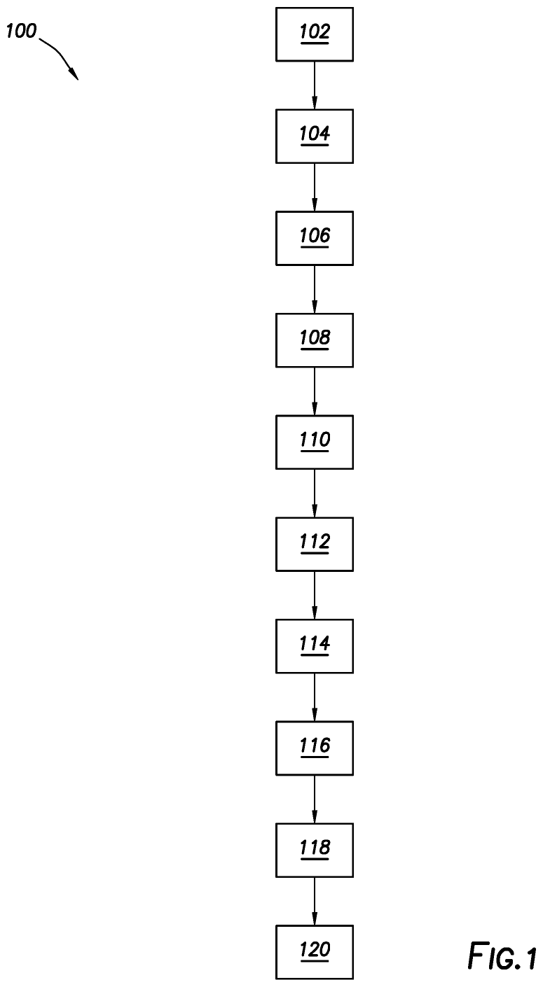

The present embodiment is for a method of forming a solid oxide fuel cell 100. As additionally depicted in FIG. 1, the method begins by tape casting an anode support 102. Next an anode functional layer slurry comprising of NiO and ScCeSZ ceramic powder is coated onto the anode support 104. The anode functional layer slurry is then dried to form an NiO—ScCeSZ anode functional layer on the anode support 106. A first electrolyte layer comprising of a ScCeSZ slurry is then coated onto the NiO—ScCeSZ functional layer 108. The first electrolyte layer is then dried to form a ScCeSZ electrolyte layer on the NiO—ScCeSZ functional layer 110. A second electrolyte layer comprising of a samarium doped CeO₂ (SDC) slurry is then coated onto the ScCeSZ electrolyte layer 112. The second electrolyte layer is then dried to form a SDC electrolyte layer on the ScCeSZ electrolyte layer 114. The combined anode support, the NiO—ScCeSZ anode functional layer, the ScCeSZ electrolyte layer, and the SDC electrolyte layer is then sintered together 116. A cathode slurry is then coated onto the SDC electrolyte layer to form a cathode layer 118. A solid oxide fuel cell is then formed when the combined anode support, the NiO—ScCeSZ anode functional layer, the ScCeSZ electrolyte layer, the SDC electrolyte layer, and the cathode layer is then sintered together 120.

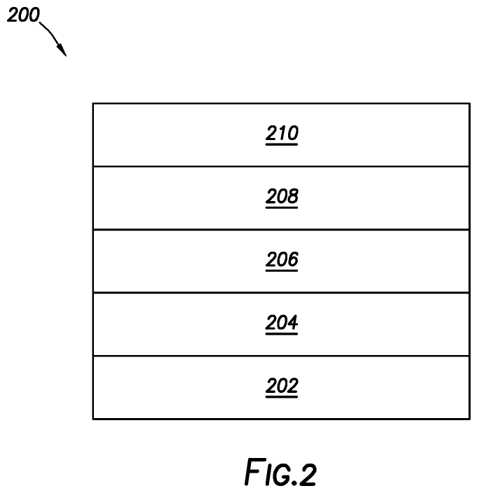

The resultant SOFC is then depicted in FIG. 2, wherein the SOFC 200 comprises an anode support 202 with an anode functional layer 204 situated on top and in contact with the anode support. The ScCeSZ electrolyte layer 206 is then disposed on top of and in contact with the anode functional layer. A SDC electrolyte layer 208 is then disposed on top of and in contact with the ScCeSZ electrolyte layer. Finally, a cathode layer 210 is disposed on top of and in contact with the SDC electrolyte layer.

In one embodiment the anode support can be prepared by a number of consecutive steps. First, NiO and ScCeSZ powders are mixed with organic solvents and dispersant on a ball mill for 24 hours. Next, suitable amounts of organic binder and plasticizer are added to the jar and the mixture is ball milled for another 24 h to obtain a homogeneous slurry. Prior to casting, the ceramic slurry is de-gassed in a desiccator under a vacuum of −64 cm mercury for 5 min to remove air bubbles. The ceramic slurry is then poured into the doctor blade on a laboratory-scale tape caster to form a continuous tape. The tape is dried on the casting bed overnight under atmospheric conditions and are cut into small anode support samples.

In one embodiment the anode functional layer slurry is coated onto the anode support. Methods of coating the anode functional layer onto the anode support can be any conventional method generally known to one skilled in the art. Non-limited examples include spray coating, ultrasonic spray coating, thermal spray coating, spin coating, dip coating, sputtering, e-beam evaporation, and electrophoretic deposition. In one non-limiting embodiment, the coating of the anode functional layer slurry is done with just one coat. In other embodiments, the coating of the anode functional layer slurry is done with multiple coats such as 2, 3, 4 or even 5. In embodiments involving multiple coats of the anode functional layer slurry it is envisioned that for some embodiments sufficient time would be permitted between coats to allow the preceding layer to dry. In other embodiments, multiple coats are immediately coated on top of each other without allowing time for the preceding layer to dry.

In one example the anode functional layer slurry comprises NiO and ScCeSZ ceramic powder. The weight percentage of NiO in the anode functional layer slurry can range from about 5 wt % to about 6 wt %, or more specifically, around 5.5 wt %. The weight percentage of ScCeSZ ceramic powder in the anode functional layer slurry can range from about 4 wt % to about 5 wt %, or more specifically, around 4.5 wt %. In another embodiment, the anode functional layer slurry comprises NiO, ScCeSZ, a dispersant, a binder, and a solvent. Examples of dispersants include triethanol amine, stearic acid, citric acid, dibutyl amine, and fish oil. Examples of binders include polyvinyl butyral, polyvinyl alcohol, polyethyl methacrylate, and methyl cellulose. Examples of solvents include ethyl alcohol, toluene, methyl ethyl ketone, isopropyl alcohol, and water.

The anode functional layer slurry is then dried at either an elevated temperature or room temperature to form an NiO—ScCeSZ anode functional layer on the anode support. The drying temperature and time of the anode functional layer slurry is dependent upon the choice of solvent in the anode functional layer slurry. The thickness of the NiO—ScCeSZ anode functional layer can range from about 5 to about 50 μm.

In one embodiment the first electrolyte layer is coated onto the NiO—ScCeSZ anode functional layer. Methods of coating the first electrolyte layer onto the NiO—ScCeSZ anode functional layer can be any conventional method generally known to one skilled in the art. Non-limited examples include spray coating, ultrasonic spray coating, thermal spray coating, spin coating, dip coating, sputtering, e-beam evaporation, and electrophoretic deposition. In one non-limiting embodiment, the coating of the first electrolyte layer is done with just one coat. In other embodiments, the coating of the first electrolyte layer is done with multiple coats such as 2, 3, 4 or even 5. In embodiments involving multiple coats of the first electrolyte layer it is envisioned that for some embodiments sufficient time would be permitted between coats to allow the preceding layer to dry. In other embodiments, multiple coats are immediately coated on top of each other without allowing time for the preceding layer to dry.

In one example the first electrolyte layer comprises ScCeSZ slurry. The weight percentage of ScCeSZ in the first electrolyte layer can range from about 2.5 wt % to about 3.5 wt %, or more specifically, around 3 wt %. In another embodiment, the first electrolyte layer comprises ScCeSZ, a dispersant, a binder and a solvent. Examples of dispersants include triethanol amine, stearic acid, citric acid, dibutyl amine, and fish oil. Examples of binders include polyvinyl butyral, polyvinyl alcohol, polyethyl methacrylate, and methyl cellulose. Examples of solvents include ethyl alcohol, toluene, methyl ethyl ketone, isopropyl alcohol, and water.

The first electrolyte layer is then dried at either an elevated temperature or room temperature to form a ScCeSZ electrolyte layer on top of the anode functional layer. The drying temperature and time of the ScCeSZ electrolyte layer is dependent upon the choice of solvent in the first electrolyte layer. The thickness of the ScCeSZ electrolyte layer can range from about 1.5 μm to about 2.5 μm. In other embodiments, the thickness of the ScCeSZ electrolyte layer is 2 μm.

In one embodiment the second electrolyte layer is coated onto the ScCeSZ electrolyte layer. Methods of coating the second electrolyte layer onto the ScCeSZ electrolyte layer can be any conventional method generally known to one skilled in the art. Non-limited examples include spray coating, ultrasonic spray coating, thermal spray coating, spin coating, dip coating, sputtering, e-beam evaporation, and electrophoretic deposition. In one non-limiting embodiment, the coating of the second electrolyte layer is done with just one coat. In other embodiments, the coating of the second electrolyte layer is done with multiple coats such as 2, 3, 4 or even 5. In embodiments involving multiple coats of the second electrolyte layer it is envisioned that for some embodiments sufficient time would be permitted between coats to allow the preceding layer to dry. In other embodiments, multiple coats are immediately coated on top of each other without allowing time for the preceding layer to dry.

In one example the second electrolyte layer comprises a samarium doped CeO₂ (SDC) slurry onto the ScCeSZ electrolyte layer. The weight percentage of SDC in the second electrolyte layer can range from about 9 wt % to about 11 wt %, or more specifically, around 10 wt %. In another embodiment, the second electrolyte layer comprises SDC, a dispersant, a binder and a solvent. Examples of dispersants include triethanol amine, stearic acid, citric acid, dibutyl amine, and fish oil. Examples of binders include polyvinyl butyral, polyvinyl alcohol, polyethyl methacrylate, and methyl cellulose. Examples of solvents include ethyl alcohol, toluene, methyl ethyl ketone, isopropyl alcohol, and water.

The second electrolyte layer is then dried at either an elevated temperature or room temperature to form a SDC electrolyte layer on top of the ScCeSZ electrolyte layer. The drying temperature and time of the SDC electrolyte layer is dependent upon the choice of solvent in the second electrolyte layer. The thickness of the SDC electrolyte layer can range from about 9.5 μm to about 10.5 μm. In other embodiments, the thickness of the SDC electrolyte layer is 10 μm.

The combined anode support, the NiO—ScCeSZ anode functional layer, the ScCeSZ electrolyte layer, and the SDC electrolyte layer can be sintered together at low temperature. Low temperature sintering can generally be defined in this situation as temperatures less than 1300° C. or even 1250° C. In other embodiments, low temperature sintering can mean temperatures ranging from about 1000° C. to about 1300° C. In more specific embodiments, low temperature sintering can mean 1250° C. The temperature ramping of the sintering can also be low, from about 1° C./min to about 2° C./min. The time of the sintering can range from around 1 hour to 2 hours to even 3 hours.

After sintering, the combined anode support, the NiO—ScCeSZ anode functional layer, the ScCeSZ electrolyte layer, and the SDC electrolyte layer can be cooled to room temperature prior to the application of the cathode slurry.

In one embodiment the cathode slurry is coated onto the SDC electrolyte layer. Methods of coating the cathode slurry onto the SDC electrolyte layer can be any conventional method generally known to one skilled in the art. Non-limited examples include spray coating, ultrasonic spray coating, thermal spray coating, spin coating, dip coating, sputtering, e-beam evaporation, and electrophoretic deposition. In one non-limiting embodiment, the coating of the cathode slurry is done with just one coat. In other embodiments, the coating of the second electrolyte layer is done with multiple coats such as 2, 3, 4 or even 5. In embodiments involving multiple coats of the cathode slurry it is envisioned that for some embodiments sufficient time would be permitted between coats to allow the preceding layer to dry. In other embodiments, multiple coats are immediately coated on top of each other without allowing time for the preceding layer to dry.

In one example the cathode slurry comprises SDC and samarium strontium cobaltite (SSC). Cathode material can also be a mixture of gadolinium-doped ceria (Ce_{0.9}Gd_{0.1}O₂) and lanthanum strontium cobalt ferrite (La_{0.6}Sr_{0.4}Co_{0.2}Fe_{0.8}O₃) or a mixture of GDC or SDC and any of the following: Pr_{0.5}Sr_{0.5}FeO_{3-δ}; Sr_{0.9}Ce_{0.1}Fe_{0.8}Ni_{0.2}O_{3-δ}; Sr_{0.8}Ce_{0.1}Fe_{0.7}Co_{0.3}O_{3-δ}; LaNi_{0.6}Fe_{0.4}O_{3-δ}; Pr_{0.8}Sr_{0.2}Co_{0.2}Fe_{0.8}O_{3-δ}; Pr_{0.7}Sr_{0.3}Co_{0.2}Mn_{0.8}O_{3-δ}; Pr_{0.8}Sr_{0.2}FeO_{3-δ}; Pr_{0.6}Sr_{0.4}Co_{0.8}Fe_{0.2}O_{3-δ}; Pr_{0.4}Sr_{0.6}Co_{0.8}Fe_{0.2}O_{3-δ}; Pr_{0.7}Sr_{0.3}Co_{0.9}Cu_{0.1}O_{3-δ}; Ba_{0.5}Sr_{0.5}Co_{0.8}Fe_{0.2}O_{3-δ}; Sm_{0.5}Sr_{0.5}CoO_{3-δ}; and LaNi_{0.6}Fe_{0.4}O_{3-δ}. The weight percentage of SSC in the cathode slurry can range from about 10 wt % to about 14 wt %, or more specifically, around 12 wt %. The weight percentage of SDC in the cathode slurry can range from about 6 wt % to about 10 wt %, or more specifically, around 8 wt %. In another embodiment, the cathode slurry comprises SDC, SSC, a dispersant, a binder and a solvent. Examples of dispersants include triethanol amine, stearic acid, citric acid, dibutyl amine, and fish oil. Examples of binders include polyvinyl butyral, polyvinyl alcohol, polyethyl methacrylate, and methyl cellulose. Examples of solvents include ethyl alcohol, toluene, methyl ethyl ketone, isopropyl alcohol, and water.

The cathode slurry is then dried at either an elevated temperature or room temperature to form a cathode layer on top of the SDC electrolyte layer. The drying temperature and time of the cathode layer is dependent upon the choice of solvent in the cathode slurry. The thickness of the cathode layer can range from about 10 to about 50 μm.

The combined anode support, the NiO—ScCeSZ anode functional layer, the ScCeSZ electrolyte layer, the SDC electrolyte layer, and cathode layer can be sintered together at low temperature to form the SOFC. Low temperature sintering can generally be defined in this situation as any temperatures less than 1000° C. or even 950° C. In other embodiments, low temperature sintering can mean any temperature below the sintering time of the combined anode support, the NiO—ScCeSZ anode functional layer, the ScCeSZ electrolyte layer, and the SDC electrolyte layer. In other embodiments, low temperature sintering can mean temperatures ranging from about 900° C. to about 1000° C. In more specific embodiments, low temperature sintering can mean 950° C. The temperature ramping of the sintering can also be low, from about 1° C./min to about 2° C./min. The time of the sintering can range from around 1 hour to 2 hours to even 3 hours.

The following examples of certain embodiments of the invention are given. Each example is provided by way of explanation of the invention, one of many embodiments of the invention, and the following examples should not be read to limit, or define, the scope of the invention.

### Example 1

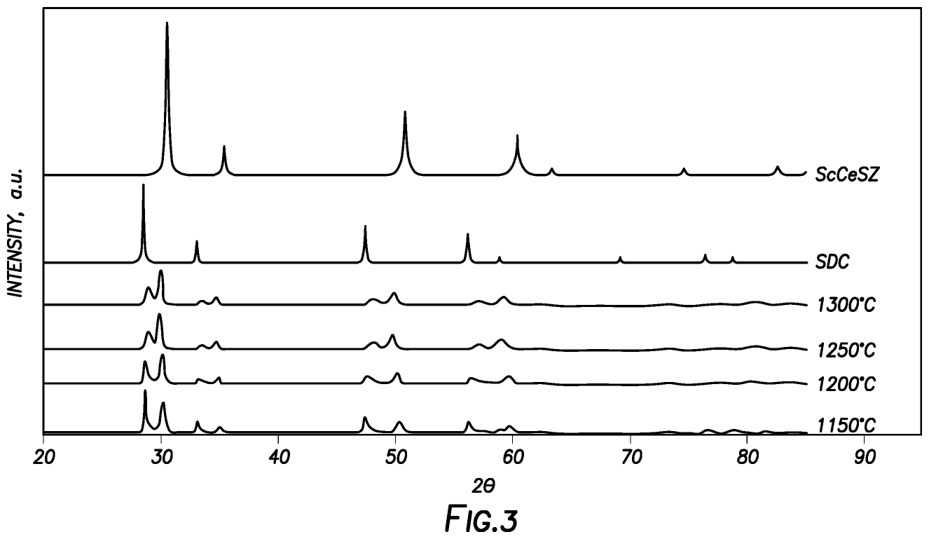

Mixtures of ScCeSZ and SDC powders in a weight ratio of 1:1 were calcined and different temperatures from around 1150° C., 1200° C., 1250° C., and 1300° C. FIG. 3 depicts the XRD patterns of the results. For comparative example ScCeSZ and SDC were also subject to XRD analysis. No new peaks were observed in the XRD patterns for the ScCeSZ-SDC samples, hypothesizing that there were no significant chemical reactions between ScCeSZ and SDC at temperatures up to 1300° C. However, the ScCeSZ peaks shift slightly to lower angles and the SDC peaks shift to higher angles even at 1200° C. This result hypothosizes that slight interdiffusion occurred between ScCeSZ and SDC, and the interdiffusion increased as the calcination temperature was raised from 1200 to 1300° C.

### Example 2

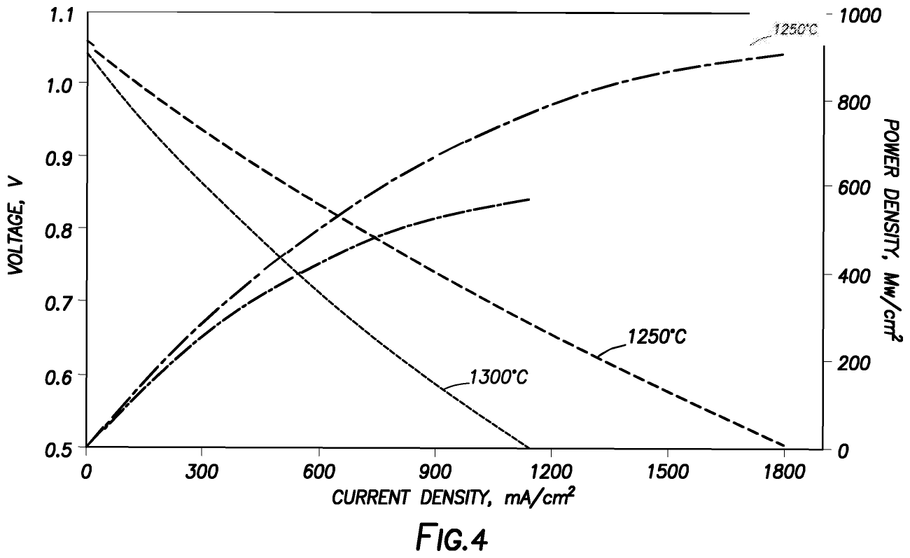

FIG. 4 depicts the performance of three different layered electrolyte cells (anode support, NiO—ScCeSZ anode functional layer, ScCeSZ electrolyte layer and SDC electrolyte layer) one of which was sintered at 1300° C. at 2 μm and two which were sintered at 1250° C. at 1 μm and 2 μm. The current-voltage data was collected at 650° C. in ambient air with humidified hydrogen as the fuel.

### Example 3

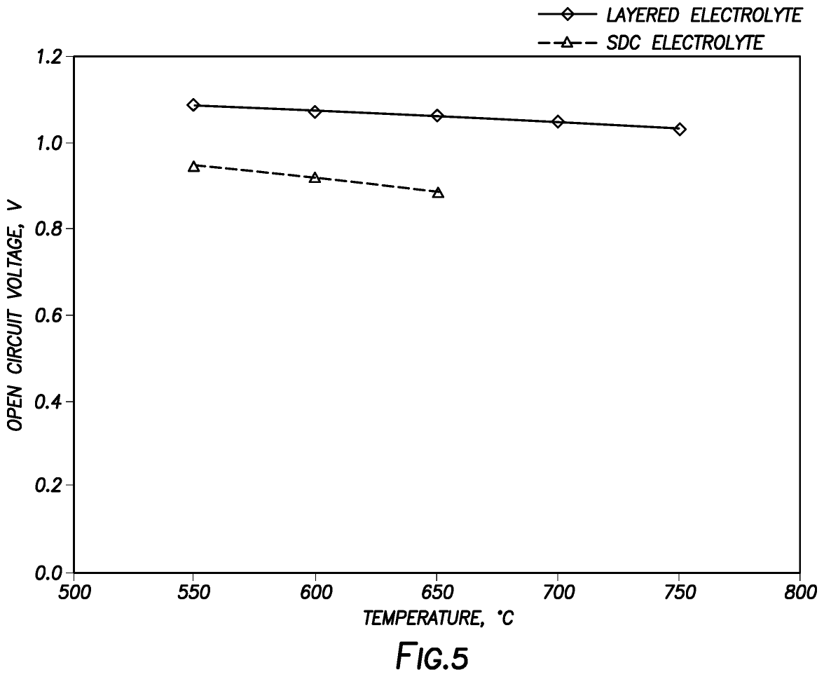

FIG. 5 depicts the open circuit voltage of a NiO—ScCeSZ anode supported cell compared with regular SDC electrolyte cell. The open circuit voltage was collected in ambient air with humidified hydrogen as the fuel.

### Example 4

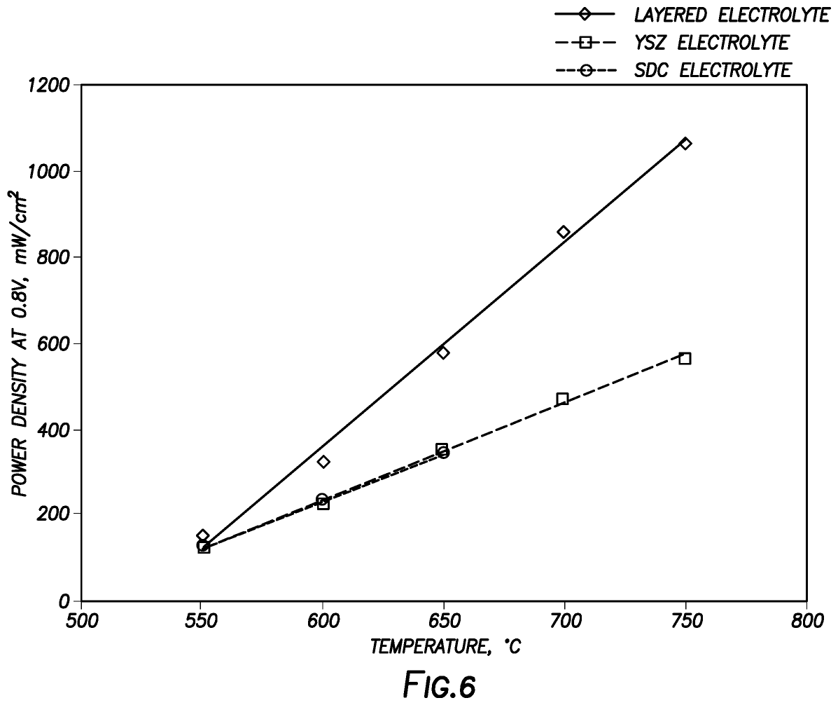

FIG. 6 depicts the power density of a NiO—ScCeSZ anode supported cell compared with regular SDC electrolyte cell and a yttria-stabilized zirconia electrolyte cell. The power density was collected in ambient air with humidified hydrogen as the fuel.

### Example 5

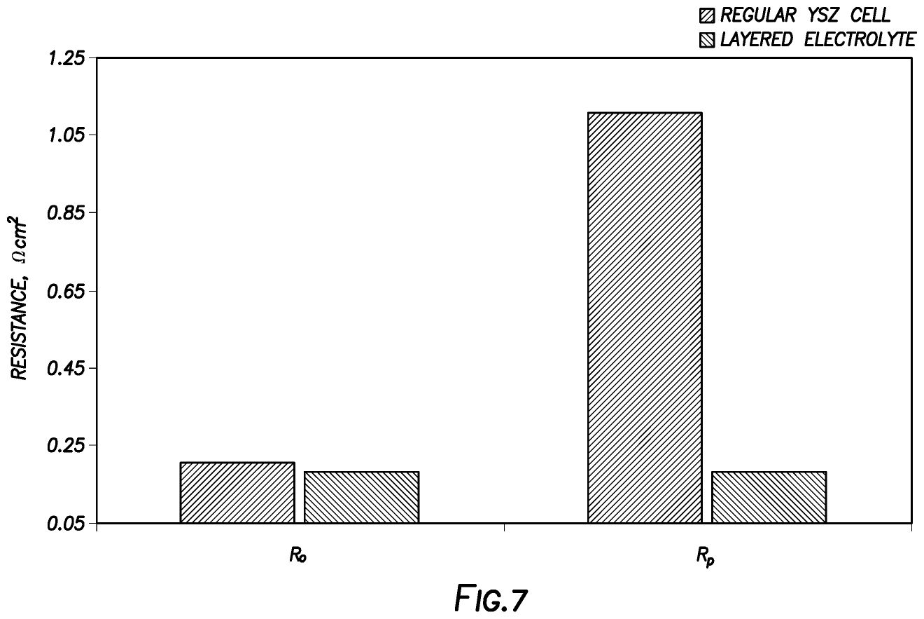

FIG. 7 depicts the AC impedance analysis of a NiO—ScCeSZ anode supported cell compared with regular yttria-stabilized zirconia electrolyte cell. The AC impedance analysis was collected at 650° C. in ambient air with humidified hydrogen as the fuel.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method comprising:
tape casting an anode support;
coating an anode functional layer slurry comprising of NiO and ScCeSZ ceramic powder onto the anode support;
drying the anode functional layer slurry to form an NiO—ScCeSZ anode functional layer on the anode support;
coating a first electrolyte layer comprising of a ScCeSZ slurry onto the NiO—ScCeSZ functional layer;
drying the first electrolyte layer to form a ScCeSZ electrolyte layer on the NiO—ScCeSZ functional layer;
coating a second electrolyte layer comprising of a samarium doped CeO₂ (SDC) slurry onto the ScCeSZ electrolyte layer;
drying the second electrolyte layer to form a SDC electrolyte layer on the ScCeSZ electrolyte layer;
sintering the combined anode support, the NiO—ScCeSZ anode functional layer, the ScCeSZ electrolyte layer, and the SDC electrolyte layer together;
coating a cathode slurry onto the SDC electrolyte layer to form a cathode layer;
sintering the combined anode support, the NiO—ScCeSZ anode functional layer, the ScCeSZ electrolyte layer, the SDC electrolyte layer, and the cathode layer to form a solid oxide fuel cell.

2. The method of claim 1, wherein the sintering of the combined anode support, the NiO—ScCeSZ functional layer, the ScCeSZ electrolyte layer, and the SDC electrolyte layer occurs at temperatures from about 1,200° C. to about 1,300° C. for around 2 hours.

3. The method of claim 1, wherein the weight percent of the NiO of the anode functional layer slurry ranges from about 5 wt % to about 6 wt %.

4. The method of claim 1, wherein the weight percent of the ScCeSZ ceramic powder of the anode functional layer slurry ranges from about 4 wt % to about 5 wt %.

5. The method of claim 1, wherein the thickness of the NiO—ScCeSZ anode functional layer ranges from about 5 to about 50 μm.

6. The method of claim 1, wherein the weight percent of the ScCeSZ slurry of the first electrolyte layer ranges from about 2.5 wt % to about 3.5 wt %.

7. The method of claim 1, wherein the thickness of the ScCeSZ electrolyte layer ranges from about 1.5 μm to about 2.5 μm.

8. The method of claim 1, wherein the weight percent of the SDC slurry of the second electrolyte layer ranges from about 9 wt % to about 11 wt %.

9. The method of claim 1, wherein the thickness of the SDC electrolyte layer ranges from about 9.5 μm to about 10.5 μm.

10. The method of claim 1, wherein the drying of the first electrolyte layer occurs at temperatures less than 50° C.

11. The method of claim 1, wherein the drying of the second electrolyte layer occurs at temperatures less than 50° C.

12. The method of claim 1, wherein the coating can be done by spray coating, ultrasonic spray coating, thermal spray coating, spin coating, dip coating, sputtering, e-beam evaporation, and electrophoretic deposition.

13. A method comprising:
tape casting an anode support;
spray coating an anode functional layer slurry consisting of NiO, ScCeSZ ceramic powder, and ethyl alcohol onto the anode support;
drying the anode functional layer slurry, at temperatures less than 50° C., to form an NiO—ScCeSZ anode functional layer on the anode support;
spray coating a first electrolyte layer consisting of a ScCeSZ slurry onto the NiO—ScCeSZ functional layer;
drying the first electrolyte layer, at temperatures less than 50° C., to form a ScCeSZ electrolyte layer on the NiO—ScCeSZ functional layer;
spray coating a second electrolyte layer consisting of a samarium doped CeO₂ (SDC) slurry onto the ScCeSZ electrolyte layer;
drying the second electrolyte layer, at temperatures less than 50° C., to form a SDC electrolyte layer on the ScCeSZ electrolyte layer;
sintering the combined anode support, the NiO—ScCeSZ anode functional layer, the ScCeSZ electrolyte layer, and the SDC electrolyte layer together, at temperatures from about 1,000° C. to about 1,300° C.;
cooling the combined anode support, the NiO—ScCeSZ anode functional layer, the ScCeSZ electrolyte layer, and the SDC electrolyte layer to room temperature;
spray coating a cathode slurry onto the SDC electrolyte layer to form a cathode layer;
sintering the combined anode support, the NiO—ScCeSZ anode functional layer, the ScCeSZ electrolyte layer, the SDC electrolyte layer, and the cathode layer, at a temperature below 1,000° C., to form a solid oxide fuel cell.

14. The method of claim 13, wherein the sintering of the combined anode support, the NiO—ScCeSZ anode functional layer, the ScCeSZ electrolyte layer, and the SDC electrolyte layer occurs at temperatures from about 1,200° C. to about 1,300° C. for around 2 hours.

15. The method of claim 13, wherein the weight percent of the NiO of the anode functional layer slurry ranges from about 5 wt % to about 6 wt %.

16. The method of claim 13, wherein the weight percent of the ScCeSZ ceramic powder of the anode functional layer slurry ranges from about 4 wt % to about 5 wt %.

17. The method of claim 13, wherein the thickness of the NiO—ScCeSZ anode functional layer ranges from about 5 to about 50 μm.

18. The method of claim 13, wherein the weight percent of the ScCeSZ slurry of the first electrolyte layer ranges from about 2.5 wt % to about 3.5 wt %.

19. The method of claim 13, wherein the thickness of the ScCeSZ electrolyte layer ranges from about 1.5 μm to about 2.5 μm.

20. The method of claim 13, wherein the weight percent of the SDC slurry of the second electrolyte layer ranges from about 9 wt % to about 11 wt %.

21. The method of claim 13, wherein the thickness of the SDC electrolyte layer ranges from about 9.5 μm to about 10.5 μm.

22. A method comprising:
tape casting an anode support;
ultrasonic spray coating an anode functional layer slurry comprising of 5.5 wt % NiO and 4.5 wt % ScCeSZ ceramic powder, and ethyl alcohol onto the anode support, wherein the spray coating is done four times at a deposition rate of 1.0 mL/min;
drying the anode functional layer slurry, at temperatures less than 50° C., to form an NiO—ScCeSZ anode functional layer on the anode support;
ultrasonic spray coating a first electrolyte layer consisting of a 3 wt % ScCeSZ slurry onto the NiO—ScCeSZ anode functional layer;
drying the first electrolyte layer, at temperatures less than 50° C., to form a ScCeSZ electrolyte layer on the NiO—ScCeSZ anode functional layer, wherein the thickness of the ScCeSZ electrolyte layer ranges from about 1.5 m to about 2.5 m;
ultrasonic spray coating a second electrolyte layer consisting of a 10 wt % samarium doped CeO₂ (SDC) slurry onto the ScCeSZ electrolyte layer;
drying the second electrolyte layer, at temperatures less than 50° C., to form a SDC electrolyte layer on the ScCeSZ electrolyte layer, wherein the thickness of the SDC electrolyte layer ranges from about 9.5 μm to about 10.5 μm;
sintering the combined anode support, the NiO—ScCeSZ functional layer, the ScCeSZ electrolyte layer, and the SDC electrolyte layer together, at temperatures from about 1,000° C. to about 1,300° C.;
cooling the combined anode support, the NiO—ScCeSZ anode functional layer, the ScCeSZ electrolyte layer, and the SDC electrolyte layer to room temperature;
ultrasonic spray coating a cathode slurry onto the SDC electrolyte layer to form a cathode layer;
sintering the combined anode support, the NiO—ScCeSZ anode functional layer, the ScCeSZ electrolyte layer, the SDC electrolyte layer, and the cathode layer, at a temperature below 1,000° C., to form a solid oxide fuel cell.
